(19) United States
(12) Patent Application Publication
(10) Pub. No.: US 2009/0196524 A1
(43) Pub. Date: Aug. 6, 2009

(54) System and method for sharpening of digital images

(75) Inventor: Ian Godin, Burbank, CA (US)

Correspondence Address: DTS, INC., 5171 CLARETON DRIVE, AGOURA HILLS, CA, 91301, US

(73) Assignee: DTS Digital Images, Inc.

(21) Appl. No.: 12/012,741

(22) Filed: Feb. 5, 2008

(51) Int. Cl. G06K 9/40

(52) U.S. Cl. 382/263

(57) ABSTRACT

Sharpening of edges in digital images without introducing unwanted artifacts is accomplished by first sharpening the digital image using a conventional sharpening filter. The digital image is separately processed with dilation and erosion operators to respectively grow the spatial extent of bright regions and shrink the spatial extent of bright regions. The sharpened, dilated and eroded images are then combined to produce a sharpened image that preserves the sharpened spatial transitions at the edges while suppressing the local contrast enhancement and any ringing.

### BACKGROUND OF THE INVENTION

1. Field of the Invention

This invention relates to “sharpening” of digital images and more particularly to a system and method for sharpening images without creating unwanted artifacts.

2. Description of the Related Art

Digital cameras or digital scans of film produce images that contain a range of acutance or “softness”. Higher acutance equals a sharper image. Sharpening filters exaggerate the light-dark contrast between the edges of an object to sharpen the spatial transition at edges and reveal fine details that otherwise would never have been seen in the original, making images appear more crisp and clear. Conventional sharpening filters include Unsharp Masking, Laplacian or Fourier enhancement among others. Sharpening filters are a flexible and powerful way to sharpen the spatial transition at edges. However, it is easy to create unwanted and conspicuous edge effects if the amount of sharpening is too much.

### SUMMARY OF THE INVENTION

The present invention provides a system and method that allows for stronger sharpening of edges in digital images without introducing unwanted artifacts.

This is accomplished by first sharpening the digital image using a core sharpening filter such as Unsharp Masking, Laplacian and Fourier enhancement. The digital image is separately processed with a dilation operator to grow the spatial extent of bright regions and shrink the spatial extent of dark regions and an erosion operator to shrink the spatial extent of bright regions and grow the spatial extent of dark regions. The amount of dilation and erosion and a ‘size’ parameter embodied in the sharpening filter are related to a target edge size in the image. The sharpened, dilated and eroded images are then combined to produce a sharpened image that preserves the sharpened spatial transitions along the edges while suppressing the local contrast enhancement at edge borders and any ringing outside the borders. As a result, the ‘amount’ of sharpening embodied in the sharpening filter can be increased and as appropriate the edge ‘size’ can be increased without inducing undesirable visual artifacts. More specifically, moderate to soft edges can be aggressively sharpened without offensive over/undershoot at the edge borders and ringing. Furthermore, the effects of sharpening on features such as single-pixel lines, noise or glint that cannot be spatially sharpened are reversed so that those features are effectively left alone by the sharpening method.

In an exemplary embodiment, the dilation operator selects a brightness value biased towards the maximum pixel brightness within a defined area for each centered pixel. The operator is suitably configured to select the maximum pixel brightness within the defined area. The defined area is typically an N×N region where N is twice the target edge ‘size’ plus one so that the dilated edges coincide with the first overshoot on the bright side of an edge border. However, the defined area may have other sizes or shapes and may be computed as two separable one-dimensional operators. Similarly the erosion operator selects a brightness value biased towards the minimum pixel brightness within a defined area for each centered pixel, typically the minimum pixel brightness. The defined areas for erosion and dilation are typically but not necessarily the same. The size is suitably selected so that the eroded edges coincide with the first undershoot on the dark side of an edge border. When used in conjunction with an unsharp masking sharpening algorithm, the defined areas are suitably the same size as the unsharp mask.

The sharpened, dilated and eroded images are suitably combined by a first operator that selects the minimum pixel brightness from the sharpened and dilated images for each pixel to produce an intermediate sharpened image and a second operator that selects the maximum pixel brightness from the intermediate sharpened and eroded images for each pixel to produce the sharpened image. The first and second operators suppress the first overshoot and undershoot, respectively, at the edge borders while preserving the sharpened spatial transition between the edge borders. The first and second operators together also suppress any additional ringing outside the edge borders. The first and second operators are not necessarily minimum and maximum operators. The operators could in some cases select a pixel value biased towards the minimum and maximum values. The order in which the first and second operators and the dilation and erosion images are applied may be reversed without changing the results, they are equivalent.

These and other features and advantages of the invention will be apparent to those skilled in the art from the following detailed description of preferred embodiments, taken together with the accompanying drawings, in which:

### BRIEF DESCRIPTION OF THE DRAWINGS

FIG. 1 is a flow diagram for sharpening of digital images in accordance with the present invention;

FIG. 2 is a depiction of a digital image including bright objects in a dark background;

FIGS. 3a through 3c are diagrams of original and sharpened edges along a single line A-A of the digital image and exemplary sharpening filter;

FIGS. 4a and 4b are diagrams illustrating the processing of the original image with a dilation and erosion operator respectively;

FIGS. 5a and 5b are the dilated and eroded images, respectively;

FIGS. 6a and 6b are diagram of the original and dilated and original and eroded edges along line A-A;

FIG. 7 is a diagram of the overlaid sharpened, dilated and eroded edges;

FIG. 8 is a diagram illustrating the combination of the sharpened and dilated images using a minimizing operator to form an intermediate sharpened image;

FIG. 9 is a diagram illustrating the combination of the intermediate sharpened and eroded images using a maximizing operator to form an output sharpened image;

FIG. 10 is a diagram comparing the original and sharpened edge along line A-A;

FIGS. 11a through 11c are diagrams illustrating sharpening of a single-pixel line; and

FIG. 12 is a process diagram illustrating the intake, processing and outflow of sharpened images.

### DETAILED DESCRIPTION OF THE INVENTION

The present invention describes a system and method for sharpening of the spatial transitions of edges in digital images that provides for more aggressive sharpening of the spatial transitions while suppressing the local contrast enhancement (under/overshoot) at edge borders and ringing outside the edge borders normally associated with such aggressive sharpening. Furthermore, the effects of sharpening on features such as single-pixel lines, noise or glint that cannot be spatially sharpened are reversed so that those features are effectively left alone by the sharpening method.

For purposes of explanation, the sharpening method will now be described in conjunction with a simplified digital image having idealized edges some number of pixels in width. In natural gray-scale images the edges within a single image will vary in width and contrast, will rarely be perfectly clean and will have some amount of noise. However, the method as described was developed for and effective in processing such real images although the suppression of certain artifacts may not be ideal. Furthermore, color digital images are typically represented with three color components or images for each image e.g. RGB, YUV, CIE-LAB etc. The sharpening method can be applied to one or more components and will be described as applied to a single arbitrary component. The method is also applicable to each or selected digital images from a sequence of images such as a movie or television programming.

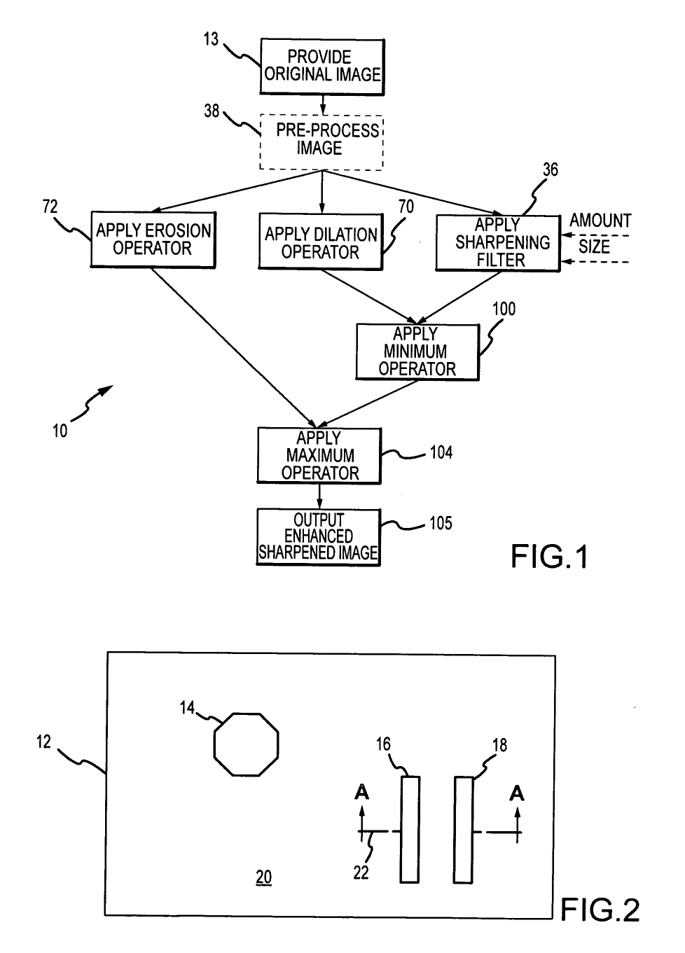

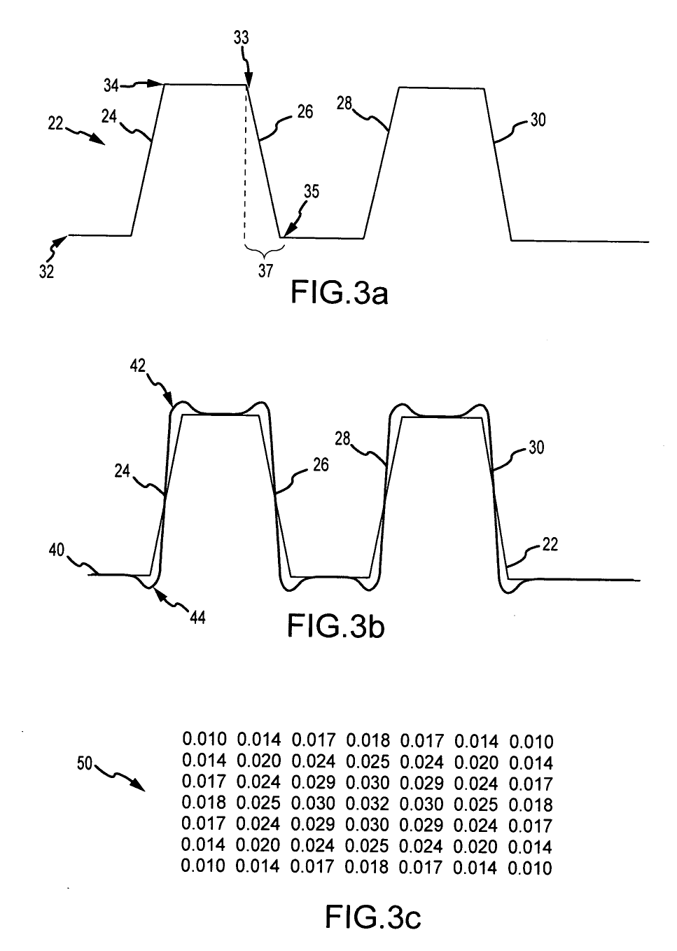

The sharpening method 10 and its application to a digital image 12 including “moderate” spatial transitions at a number of edges is illustrated in FIGS. 1 through 10. In this illustrative embodiment, the digital image 12 provided in step 13 includes an octagonal object 14 and a pair of rectangular objects 16 and 18 having bright pixel values in a dark background 20. More specifically application of the method to a single line 22 passing transversely through rectangular objects 16 and 18 along section A-A will be described. As shown in FIG. 3a, line 22 includes four edges 24, 26, 28 and 30 that transition from a bright pixel value 34 at border 33 to a dark pixel value 32 at another border 35. In this example, the spatial extent of the edge transition 37 between the edge borders is three pixels wide.

A sharpening filter such as an Unsharp Mask, Laplacian, Fourier enhancement or other is applied to the original image (step 36). The sharpening filter may and typically is applied to the entire image. Unsharp masking filters use a blurred, or “unsharp” positive to create a “mask” of the original image. The unsharped mask is then combined with the negative, creating the illusion that the resulting image is sharper than the original. Digital imaging software packages such as Adobe Photoshop or GIMP apply a Gaussian blur to a copy of the original image and then compare it to the original. If the difference is greater than a user-specified or hard-coded ‘Threshold’ setting the images are (in effect) subtracted.

Typically three settings will control digital unsharp masking; the amount, radius and threshold. The amount is listed as a percentage, and controls the magnitude of each overshoot (how much darker and how much lighter the edge borders become). This can also be thought of as how much contrast is added at the edges. It does not affect the width of the edge rims but does sharpen the spatial transition between the contrast enhanced edges. The radius affects the size of the edges to be enhanced or how wide the edge rims become, so a smaller radius enhances smaller-scale detail. Higher radius values can cause halos at the edges; a detectable faint light rim around objects. Fine detail needs a smaller radius; tiny detail of the same size as the radius width is lost. Radius and amount interact; reducing one allows more of the other. The threshold controls the minimum brightness change that will be sharpened, i.e. how far apart adjacent tonal values have to be before the filter does anything. This lack of action is important to prevent smooth areas from becoming speckled. The threshold setting can be used to sharpen more pronounced edges, while leaving more subtle edges untouched. Low values should sharpen more because fewer areas are excluded. Higher threshold values exclude areas of lower contrast.

Digital unsharp masking is a flexible and powerful way to sharpen the spatial transition at edges. However, it is easy to create unwanted and conspicuous edge effects if the amount of sharpening is too much. The over/undershoot at the edge borders caused by the local contrast enhancement can become severe and produce a glow effect. If the radius is large, the image can have multiple repeating over/undershoots, referred to as “ringing”. As a result, the amount of sharpening that can be used without introducing unwanted artifacts is typically fairly small. This is particularly problematic for standard definition images scaled up to high definition. Such images are usually soft because of the interpolation needed to create the extra pixels. If the image is three times its original size then a single pixel transition is now spread over three pixels. The amount and radius need to be increased accordingly to effectively sharpen the scaled-up image.

The sharpening filter may and typically is applied to the entire image. Alternately, the image can be “pre-processed” (step 38) to locate edges and perhaps determine their orientation and estimate their size. The information gleaned from pre-processing can be used to selectively apply the sharpening filter only to identified edges and to adaptively size the sharpening filter based on the size and orientation of the edges. This type of pre-processing can be applied to a conventional sharpening filter or the sharpening method of the present invention. However, such pre-processing adds to the computational burden of the overall method and complicates the sharpening process so that the costs may outweigh the benefits depending on the application. Noise reduction techniques may also be applied to the image as part of the pre-processing. In a low noise environment, the benefits of the sharpening method are more noticeable as the local contrast enhancement and ringing artifacts are not as obscured by noise. Preprocessing may also include scaling the resolution up from, for example, a standard definition resolution to high definition. Additional pixels are inserted and values interpolated based on the original image, which has the effect of softening all of the edges.

For the current example, the sharpening filter produces a line 40 in which the spatial transitions of edges 24, 26, 28 and 30 have been sharpened by exaggerating the light-dark contrast between the edges as shown in FIG. 3b. This exaggeration produces overshoot 42 and undershoot 44 at edge border 33 and 35, respectively, that together increase the local contrast (e.g. max/min) of each edge. In this example, the ‘size’ is not large enough to induce ringing outside the edge borders. In order to aggressively sharpen the spatial transition one must ordinarily tolerate a large increase in the local contrast, which can make the natural imagery appear harsh or fake. In an Unsharp Mask filter, the amount of overshoot/undershoot is controlled by the “amount” parameter. An exemplary 7×7 low pass spatial filter 50 (2*edge_size+1) for use in unsharp masking is illustrated in FIG. 3c. The coefficients sum to one so that the image brightness level is maintained. In general, changing the ‘amount’ parameter scales the low pass image down, while the original image is scaled up by 1+the amount. The original image is multiplied by a number larger than 1, thereby increasing the contrast. The low pass image is then subtracted, which restores the low frequencies (flat areas) to their original value, leaving an increased contrast in the high frequencies (edges).

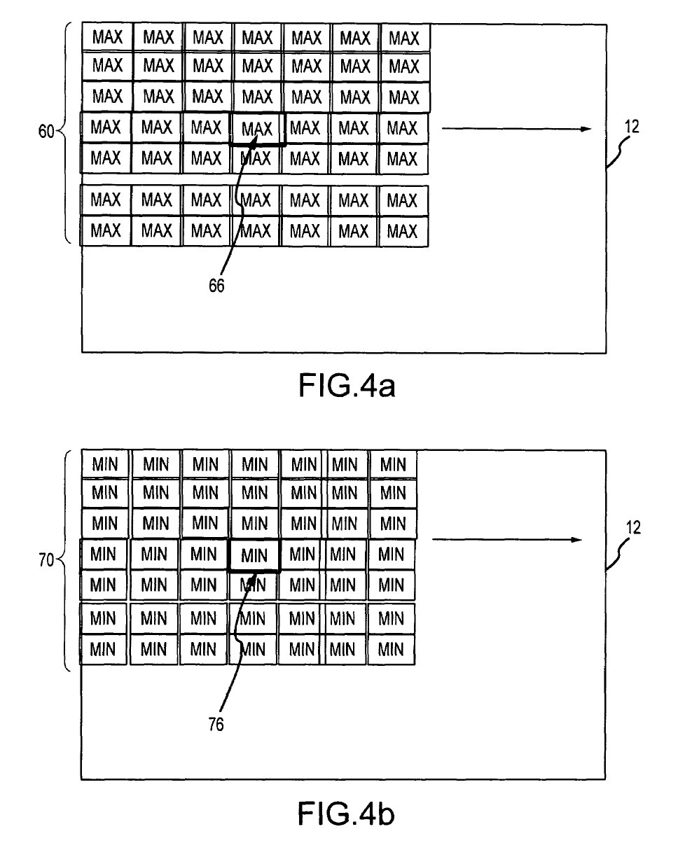

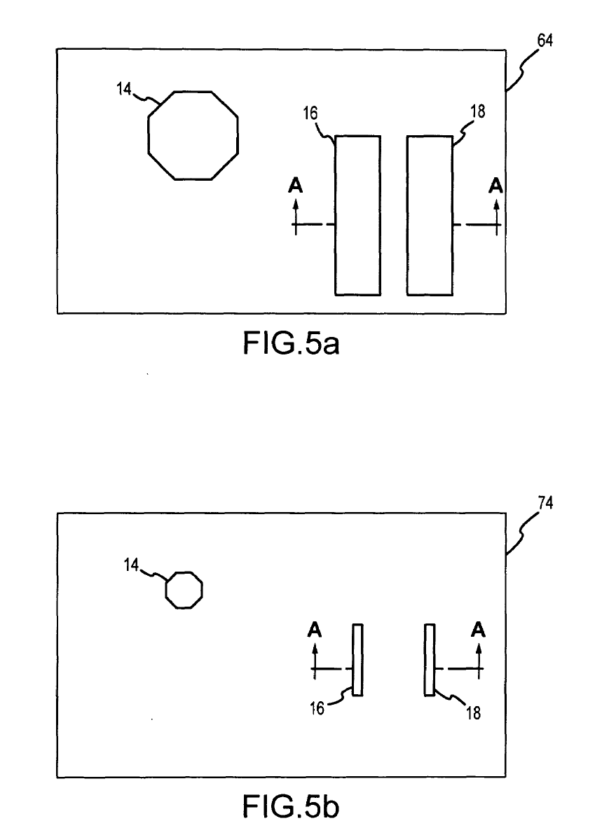

Digital image 12 is processed with a dilation operator 60 (step 62) as shown in FIG. 4a to provide a dilated image 64 that grows the spatial extent of bright regions 14, 16 and 18 and shrinks the spatial extent of dark regions 20 as shown in FIG. 5a. In this particular configuration, the dilation operator selects the maximum pixel brightness value within a 7×7 area (selected to match the unsharp mask filter size) centered about the current pixel 66 and replaces the current pixel value with the selected maximum. The dilation operator traverses the image until each center pixel value is replaced with the maximum within its area. More generally, the dilation operator selects a brightness value biased towards the maximum pixel brightness within a defined area for each centered pixel. For example a biased value could be the maximum or a weighted averaged bias towards the maximum. The defined area is typically an N×N region where N is twice the target edge ‘size’ plus one so that the dilated edges coincide with the first overshoot on the bright side of an edge. However, the defined area may have other sizes or shapes and may be computed as two separable one-dimensional operators. For a given edge size, a smaller operator will result in reduced sharpening and a larger operator will result in less ringing being removed. If the size parameter is too large, the dilation operation may overlap closely spaced edges. In particular, if the image is pre-processed to determine the size and orientation of individual edges, the size and shape of the dilation operator may be adapted (along with the sharpening filter) based on this information.

Digital image 12 is processed with an erosion operator 70 (step 72) as shown in FIG. 4b to provide a eroded image 74 that grows the spatial extent of dark regions 14, 16 and 18 and shrinks the spatial extent of bright regions 20 as shown in FIG. 5b. In this particular configuration, the erosion operator selects the minimum pixel brightness value within a 7×7 area (selected to match the unsharp mask filter size) centered about the current pixel 76 and replaces the current pixel value with the selected minimum. The erosion operator traverses the image until each center pixel value is replaced with the minimum within its area. More generally, the erosion operator selects a brightness value biased towards the minimum pixel brightness within a defined area for each centered pixel. For example a biased value could be the minimum or a weighted averaged bias towards the minimum. The defined area is typically an N×N region where N is twice the target edge ‘size’ plus one so that the eroded edges coincide with the first undershoot on the dark side of an edge. However, the defined area may have other sizes or shapes and may be computed as two separable one-dimensional operators. In particular, if the image is pre-processed to determine the size and orientation of individual edges, the size and shape of the erosion operator may be adapted (along with the sharpening filter) based on this information.

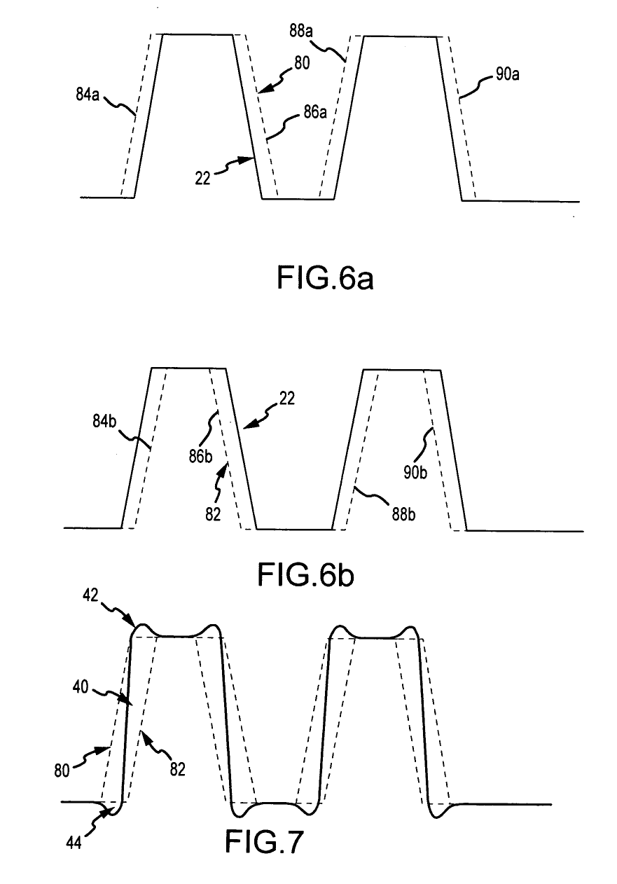

The effect of dilation and erosion on line 22 from the original image are shown in FIGS. 6a and 6b as dilated line 80 and eroded line 82, which are overlaid with the sharpened line 40 as shown in FIG. 7. In dilated line 80 the edges 84a, 86a, 88a and 90a have effectively moved outwards to increase the spatial extent of the bright region and reduce the dark region. Conversely in eroded line 82 the edges 84b, 86b, 88b and 90b have effectively moved inwards to reduce the spatial extent of the bright region and increase the dark region. The dilated and eroded edges coincide with the first overshoot 42 and undershoot 44 on the bright and dark sides of an edge having the designed for size, respectively, and the minimum and maximum brightness values associated with the local region of each dilated or eroded edge have not changed. If the response of the sharpening filter did exhibit ringing, those 2^{nd}, 3^{rd} etc. overshoot and undershoot portions would lie in areas of the dilated and eroded lines outside edge borders having the original image values.

The sharpened, dilated and eroded images are then combined to produce a sharpened image that preserves the sharpened spatial edge transitions while suppressing local contrast enhancement at the edge borders and ringing in those bright and dark regions outside the edge borders induced by the sharpening filter. Essentially a minimization operator is applied to the dilated and sharpened image to suppress the first overshoot 42 and those portions of any ringing that overshoot the original image brightness and a maximization operator is applied to the eroded and sharpened image to suppress the first undershoot 44 and those portions of any ringing that might undershoot the original image brightness. As with the dilation and erosion operators, the minimization and maximization operators do not strictly have to select the minimum or maximum brightness values. They could select a pixel value biased towards the minimum or maximum using a weight average calculation.

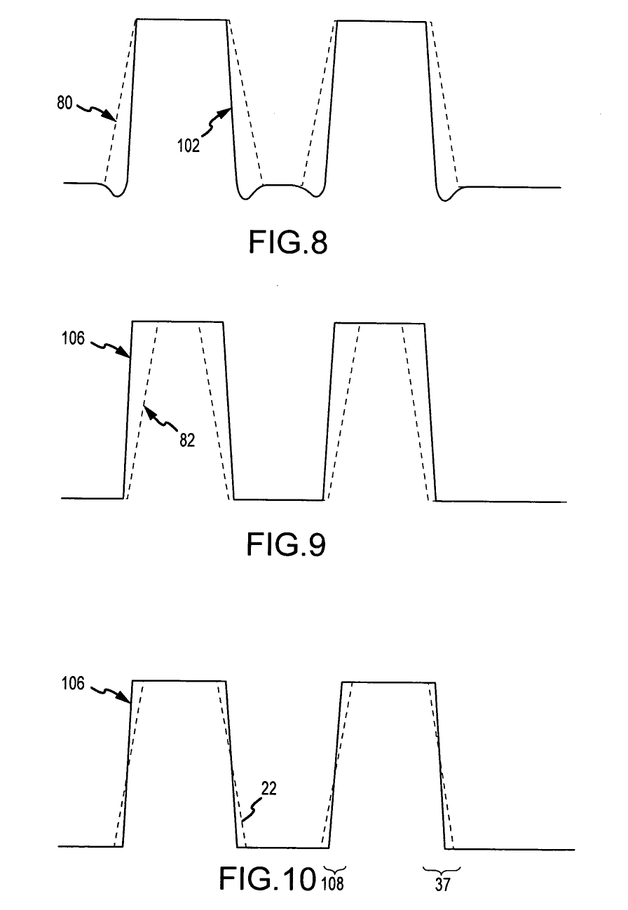

As shown in FIG. 1, one implementation is to first apply the minimization operator (step 100) to the sharpened and dilated images. The operator selects the minimum brightness value from between the two images for each pixel to construct an intermediate sharpened image. Dilated line 80 and an intermediate sharpened line 102 are depicted in FIG. 8. As shown, the minimization operation has removed overshoot 42 at the edge border without affecting the sharpness of the spatial transition between the edge borders. Thereafter, the maximization operator (step 104) is applied to the intermediate sharpened and eroded images. The operator selects the maximum brightness value from between the two images for each pixel to construct the sharpened image that is returned by the overall process (step 105). Eroded line 82 and a sharpened line 106 are depicted in FIG. 9. As shown, the maximization operation has removed undershoot 44 at the other edge border without affecting the sharpness of the spatial transition between the edge borders.

As depicted in FIG. 10, sharpened line 106 has a sharper spatial transition 108 between the edge borders than edge transition 37 of original line 22, approximately 1 pixel compared to three pixels, without the local contrast enhancement (overshoot/undershoot) at the edge borders or ringing outside the borders associated with conventional sharpening techniques. The practical benefit of the described sharpening technique is that the amount and size parameters for the core sharpening filter can be selected to more aggressively sharpen the spatial transitions of edges without inducing visual artifacts. If there are thresholds for the amount and size parameters when used with only the core sharpening filter that beyond which induce noticeable or unacceptable visual artifacts, the method allows those parameters to be set beyond the respective thresholds without experiencing the noticeable or unacceptable visual artifacts. This is a considerable advantage when processing imagery in its native resolution. However, the technique really shines when used in conjunction with imagery that has been scaled-up to a higher resolution which inherently softens the edges. It is important to note that the application of the sharpening method was described for an idealized edge having the same size as the selected size parameter. For non-idealized edge of the same size, the enhancement technique will sharpen the edge transition, suppress local contrast enhancement at the borders and suppress ringing outside the borders but the enhancement will not be ideal. Typically a real image will include edges of many different sizes. Application of the sharpening technique to smaller edges may not suppress ringing as effectively and to larger edges may soften the sharpened edge transition a bit. This is similar to the tradeoff made in setting the size parameter in the core sharpening filter.

Another important benefit of the sharpening technique of the present invention is that when it is applied to certain objects that either are edges or appear to be edges it has the net effect of doing nothing to the object. The minimization and maximization operators that use the dilated and eroded images essentially reverse the effects of the core sharpening filter. Why is this important? Certain objects such as perfect 1-pixel edges, lines, noise, glint etc. cannot be spatially sharpened. Therefore the application of the core sharpening filter merely distorts their peak brightness and induces ringing. If the image is pre-processed to remove these objects then conventional sharpening techniques are less offensive. However, such pre-processing is difficult and computationally intensive. Instead the sharpening method can be applied to the entire image without distorting these edge type features. For non-ideal objects, there may be a small amount of distortion but far less than would occur if processed with only the core sharpening filter.

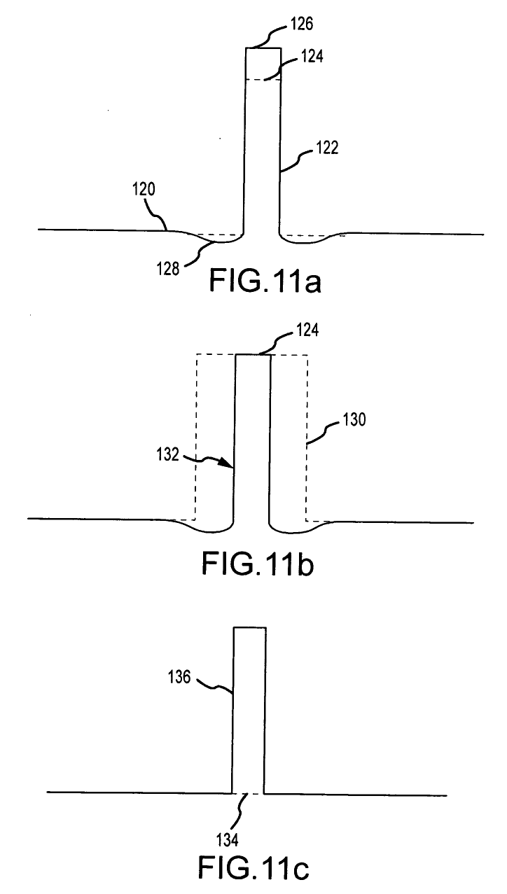

An example of how this works is depicted in FIGS. 11a-11c. A line 120 includes a single pixel 122 having brightness 124. This might be a single noise pixel or a single-pixel line. In either case the edge is as sharp as it can be; there is no spatial transition from dark to bright. Application of the core sharpening filter causes the peak brightness 126 to increase and creates undershoot 128 to either side of the peak. Application of the minimization operator to the sharpened pixel and dilated pixel 130 reduced the peak brightness to its original value 124 in intermediate sharpened pixel 132. Application of the maximization operator to intermediate sharpened pixel 132 and eroded pixel 134 which has a uniformly dark level eliminates the undershoot 128 to produce a sharpened pixel 136 that is, in this idealized example, identical to the original pixel 122. The introduction of visual artifacts in structure such as single pixel noise, single pixel lines, glint etc. that you either do not wish or can not sharpen is a substantive limitation of conventional sharpening techniques. The presented sharpening technique overcomes this limitation by reversing the effects of the core sharpening filter at ‘edge’ borders and outside the borders.

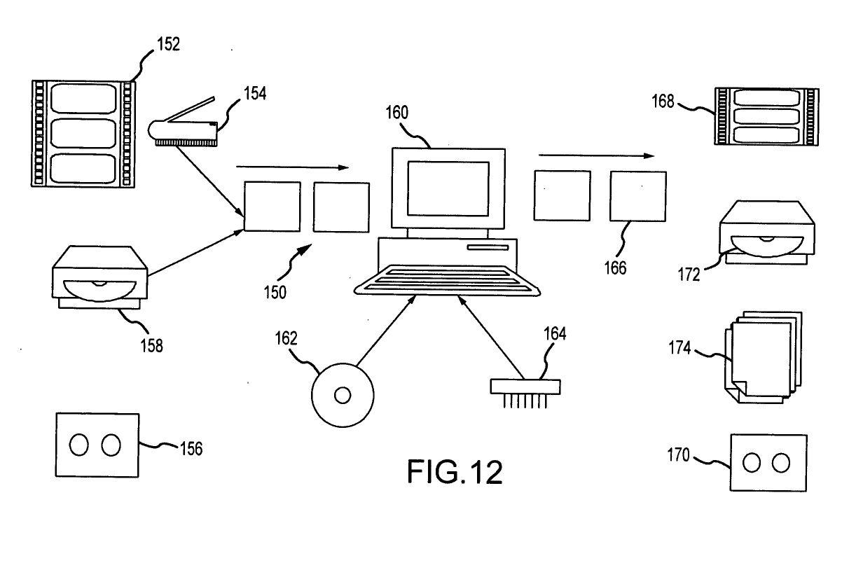

A typical process flow illustrating the intake, processing and outflow of digital images is illustrated in FIG. 12. Digital images 150 are received in any one of a number of ways. The customer may provide film 152 which is run through a film scanner 154 to digitize the film. Alternately the customer may provide the digital images 150 on a video tape 156. A tape player machine is hooked up to a computer provided with special hardware to read the digital signal from the tape player. The computer records from the tape player in real time into the digital image files 150. Sometimes the customer has already digitized the images and the digital images 150 are received on a firewire or USB drive 158.

A computer 160, which may be one or more computers networked together, is configured to execute the sharpening method illustrated in FIG. 1 and described above. The sharpening method may be provided as a software application on tangible media 162 such as a CD or DVD or computer memory via a download or may be hardcoded into a semiconductor device such as an IC chip 164. The computer will typically prompt the user to enter the ‘amount’ and ‘size’ parameters and possibly the ‘threshold’, which is otherwise hardcoded. Once the input parameters are selected, the computer executes the instructions dictated by the software application or dedicated hardware to execute the sharpening method on each digital image 150 and output sharpened digital images 166. As discuss previously, the computer or computers may pre-process the digital images 150 to perform noise reduction or to characterize edges for sharpening.

The sharpened digital images 166 are delivered back to the customer in much the same way as they are received. A film recorder can be used to write the images back to film 168. A computer with special hardware can be used to send the digital images to a tape recorder machine to record them on to video tape 170. The images can be copied onto a firewire or USB drive 172. Potentially the digital images can be formatted as digital image files 174 and transferred without a physical media such as via the Internet.

While several illustrative embodiments of the invention have been shown and described, numerous variations and alternate embodiments will occur to those skilled in the art. Such variations and alternate embodiments are contemplated, and can be made without departing from the spirit and scope of the invention as defined in the appended claims.

I claim:

1. A method of sharpening a digital image, comprising:
processing the digital image with a sharpening filter to provide a sharpened image including sharpened spatial edge transitions between edge borders at bright-and-dark and dark-and-bright regions of the digital image;
processing the digital image with a dilation operator to provide a dilated image that grows the spatial extent of bright regions and shrinks the spatial extent of dark regions of the digital image;
processing the digital image with an erosion operator to provide an eroded image that shrinks the spatial extent of bright regions and grows the spatial extent of dark regions of the digital image; and
combining the sharpened, dilated and eroded images to produce a sharpened image that preserves the sharpened spatial edge transitions while suppressing local contrast enhancement at the edge borders and ringing in those bright and dark regions to either side of the edge borders induced by the sharpening filter.

2. The method of claim 1, wherein the sharpening filter is characterized by user selected amount and size parameters that respectively control the magnitude of the overshoot at the edge borders and the size of the edges to be sharpened, said amount and size parameters having respective thresholds beyond which the sharpening filter produces unacceptable artifacts, further comprising:
setting the amount parameter above its threshold whereby the sharpening filter induces overshoot and undershoot at the edge borders that is suppressed by the combination of the images.

3. The method of claim 2, further comprising:
setting the size parameter above its threshold whereby the sharpening filter induces ringing outside the edge borders that is suppressed by the combination of the images.

4. The method of claim 1, wherein the dilation and erosion operators respectively select a brightness value biased towards the maximum and minimum pixel brightness within a defined area around each image pixel.

5. The method of claim 4, wherein the dilation and erosion operators respectively select the maximum and minimum pixel brightness within the defined area around each image pixel.

6. The method of claim 4, wherein the defined area is related to an edge size parameter.

7. The method of claim 6, wherein the defined area is an N×N pixel area where N equals twice the edge size plus one centered about the pixel.

8. The method of claim 7, wherein the sharpening filter comprises an unsharp masking filter that includes an N×N spatial low pass filter.

9. The method of claim 1, wherein the sharpened, dilated and eroded images are combined by:
combining the sharpened image and the dilated image using a first operator that selects a pixel brightness biased towards the minimum pixel brightness for each pixel to produce an intermediate sharpened image; and
combining the intermediate sharpened image and the eroded image using a second operator that selects a pixel brightness biased towards the maximum pixel brightness for each pixel to produce a sharpened image.

10. The method of claim 9, wherein the first operator selects the minimum pixel brightness for each pixel and the second operator selects the maximum pixel brightness for each pixel.

11. The method of claim 1, wherein the sharpened, dilated and eroded images are combined by:
combining the sharpened image and the eroded image using a first operator that selects a pixel brightness biased towards the maximum pixel brightness for each pixel to produce an intermediate sharpened image; and
combining the intermediate sharpened image and the dilated image using a second operator that selects a pixel brightness biased towards the minimum pixel brightness for each pixel to produce a sharpened image.

12. The method of claim 1, wherein the first operator selects the maximum pixel brightness for each pixel and the second operator selects the minimum pixel brightness for each pixel.

13. The method of claim 1, wherein the digital image has a first native resolution, further comprising prior to the processing:
scaling the digital image up to a second resolution greater than its first native resolution thereby increasing the width of the spatial edge transitions between edge borders.

14. The method of claim 13, wherein the sharpening filter is characterized by user selected amount and size parameters that respectively control the magnitude of the overshoot at the edge borders and the size of the edges to be sharpened, further comprising:
setting the amount parameter based on the increased width of the spatial edge transition whereby the sharpening filter induces overshoot and undershoot at the edge borders that is suppressed by the combination of the images; and
setting the size parameter based on the increased width of the spatial edge transition whereby the sharpening filter induces ringing outside the edge borders that is suppressed by the combination of the images.

15. The method of claim 1, wherein the combination of the sharpened, eroded and dilated images preserves the sharpening in the spatial edge transitions and substantially reverses the operation of the sharpening filter at and outside the edge borders.

16. One or more computer-readable media comprising computer-executable instructions that, when executed, perform the method as recited in claim 1.

17. One or more semiconductor devices comprising digital circuits configured to perform the method as recited in claim 1.

18. A method of sharpening a digital image, comprising:
processing the digital image with a sharpening filter to provide a sharpened image including sharpened spatial edge transitions between edge borders;
processing the digital image with a dilation operator that selects the maximum pixel brightness value within a first defined area around each pixel to provide a dilated image that grows the spatial extent of bright regions and shrinks the spatial extent of dark regions of the digital image;
processing the digital image with an erosion operator that selects the minimum pixel brightness value within a second defined area around each pixel to provide an eroded image that shrinks the spatial extent of bright regions and grows the spatial extent of dark regions of the digital image;
combining the sharpened image and the dilated image using a first operator that selects the minimum pixel brightness for each pixel to produce an intermediate sharpened image; and
combining the intermediate sharpened image and the eroded image using a second operator that selects the maximum pixel brightness for each pixel to produce a sharpened image.

19. The method of claim 18, wherein the sharpening filter is characterized by user selected amount and size parameters that respectively control the magnitude of the overshoot at the edge borders and a target size of the edges to be sharpened, said amount and size parameters having respective thresholds beyond which the sharpening filter produces unacceptable artifacts, further comprising:
setting the amount parameter above its threshold whereby the sharpening filter induces overshoot and undershoot at the edge borders that are suppressed by the combination of the sharpened, dilated and eroded images.

20. The method of claim 19, further comprising:
setting the size parameter above its threshold whereby the sharpening filter induces ringing outside edge borders that is by the combination of the sharpened, dilated and eroded images.

21. The method of claim 20, wherein the digital image has a first native resolution, further comprising prior to the processing:
scaling the digital image up to a second resolution greater than its first native resolution thereby increasing the width of the spatial edge transitions between edge borders, said amount and size parameters being set based on the increased with of the spatial edge transition.

22. The method of claim 18, wherein the defined area is related to an edge size parameter of the sharpening filter.

23. The method of claim 18, wherein the defined area is an N×N pixel area where N equals twice an edge size parameter plus an odd integer value centered about the pixel.

24. One or more computer-readable media comprising computer-executable instructions that, when executed, perform the method as recited in claim 18.

25. One or more semiconductor devices comprising digital circuits configured to perform the method as recited in claim 18.

26. A computer system comprising one or more processors and one or more software programs, the one or more software programs configured to:
process the digital image with a sharpening filter to provide a sharpened image including sharpened spatial edge transitions between edge borders at bright-and-dark and dark-and-bright regions of the digital image;
process the digital image with a dilation operator to provide a dilated image that grows the spatial extent of bright regions and shrinks the spatial extent of dark regions of the digital image;
process the digital image with an erosion operator to provide an eroded image that shrinks the spatial extent of bright regions and grows the spatial extent of dark regions of the digital image; and
combine the sharpened, dilated and eroded images to produce a sharpened image that preserves the sharpened spatial edge transitions while suppressing local contrast enhancement at the edge borders and ringing in those bright and dark regions to either side of the edge borders induced by the sharpening filter.

27. The computer system of claim 26, wherein the wherein the software programs are configured to:
combine the sharpened image and the dilated image using a first operator that selects a pixel brightness biased towards the minimum pixel brightness for each pixel to produce an intermediate sharpened image; and
combine the intermediate sharpened image and the eroded image using a second operator that selects a pixel brightness biased towards the maximum pixel brightness for each pixel to produce a sharpened image.

28. The computer system of claim 27, wherein the first operator selects the minimum pixel brightness for each pixel and the second operator selects the maximum pixel brightness for each pixel.

29. One or more computer-readable media having stored thereon computer executable instructions that, when executed by one or more processors, causes the one or more processors of a computer system to:
process the digital image with a sharpening filter to provide a sharpened image including sharpened spatial edge transitions between edge borders at bright-and-dark and dark-and-bright regions of the digital image;
process the digital image with a dilation operator to provide a dilated image that grows the spatial extent of bright regions and shrinks the spatial extent of dark regions of the digital image;
process the digital image with an erosion operator to provide an eroded image that shrinks the spatial extent of bright regions and grows the spatial extent of dark regions of the digital image; and
combine the sharpened, dilated and eroded images to produce a sharpened image that preserves the sharpened spatial edge transitions while suppressing local contrast enhancement at the edge borders and ringing in those bright and dark regions to either side of the edge borders induced by the sharpening filter.

30. The one or more computer-readable media of claim 29, wherein the computer executable instructions stored therein cause the one or more processors to:
combine the sharpened image and the eroded image using a first operator that selects a pixel brightness biased towards the maximum pixel brightness for each pixel to produce an intermediate sharpened image; and
combine the intermediate sharpened image and the dilated image using a second operator that selects a pixel brightness biased towards the minimum pixel brightness for each pixel to produce a sharpened image.

31. The one or more computer-readable media of claim 30, wherein the first operator selects the maximum pixel brightness for each pixel and the second operator selects the minimum pixel brightness for each pixel.

32. A semiconductor device comprising digital circuits configured to:
process the digital image with a sharpening filter to provide a sharpened image including sharpened spatial edge transitions between edge borders at bright-and-dark and dark-and-bright regions of the digital image;
process the digital image with a dilation operator to provide a dilated image that grows the spatial extent of bright regions and shrinks the spatial extent of dark regions of the digital image;
process the digital image with an erosion operator to provide an eroded image that shrinks the spatial extent of bright regions and grows the spatial extent of dark regions of the digital image; and
combine the sharpened, dilated and eroded images to produce a sharpened image that preserves the sharpened spatial edge transitions while suppressing local contrast enhancement at the edge borders and ringing in those bright and dark regions to either side of the edge borders induced by the sharpening filter.

33. The semiconductor device of claim 32, wherein the computer executable instructions stored therein cause the one or more processors to:
combine the sharpened image and the eroded image using a first operator that selects a pixel brightness biased towards the maximum pixel brightness for each pixel to produce an intermediate sharpened image; and
combine the intermediate sharpened image and the dilated image using a second operator that selects a pixel brightness biased towards the minimum pixel brightness for each pixel to produce a sharpened image.

34. The semiconductor device of claim 33, wherein the first operator selects the maximum pixel brightness for each pixel and the second operator selects the minimum pixel brightness for each pixel.

35. A system, comprising:
computer memory;
a first imaging means for capturing a digital image and storing the image in said computer memory;
one or more computer processors configured to execute instructions to process the digital image with a sharpening filter to provide a sharpened image including sharpened spatial edge transitions between edge borders at bright-and-dark and dark-and-bright regions of the digital image, process the digital image with a dilation operator to provide a dilated image that grows the spatial extent of bright regions and shrinks the spatial extent of dark regions of the digital image, process the digital image with an erosion operator to provide an eroded image that shrinks the spatial extent of bright regions and grows the spatial extent of dark regions of the digital image and combine the sharpened, dilated and eroded images to produce a sharpened digital image that preserves the sharpened spatial edge transitions while suppressing local contrast enhancement at the edge borders and ringing in those bright and dark regions to either side of the edge borders induced by the sharpening filter; and
a second imaging means for writing out the sharpened digital image to a tangible media.

36. The system of claim 35, wherein the processors are configured to:
combine the sharpened image and the dilated image using a first operator that selects a pixel brightness biased towards the minimum pixel brightness for each pixel to produce an intermediate sharpened image; and
combine the intermediate sharpened image and the eroded image using a second operator that selects a pixel brightness biased towards the maximum pixel brightness for each pixel to produce a sharpened image.

37. The system of claim 36, wherein the first operator selects the minimum pixel brightness for each pixel and the second operator selects the maximum pixel brightness for each pixel.
